(19) United States
(12) Patent Application Publication
(10) Pub. No.: US 2022/0352790 A1
(43) Pub. Date: Nov. 3, 2022

(54) DRIVE DEVICE

(71) Applicant: NIDEC CORPORATION, Kyoto (JP)

(72) Inventors: Hiroki AKAISHI, Kyoto (JP); Kazuyuki YAMAMOTO, Kyoto (JP); Ayumi NAKAGAWA, Kyoto (JP); Shohei FUJIMOTO, Kyoto (JP)

(21) Appl. No.: 17/727,835

(22) Filed: Apr. 25, 2022

(30) Foreign Application Priority Data
Apr. 28, 2021 (JP) 2021-076658

(51) Int. Cl. H02K 11/33; H02K 7/116; H02K 7/00; H02K 7/08; B60L 50/51; H02P 27/06

(52) U.S. Cl. CPC H02K 11/33; H02K 7/116; H02K 7/006; H02K 7/083; B60L 50/51; H02P 27/06

(57) ABSTRACT

A drive device includes a motor having a rotor rotatable about a motor axis, a motor housing accommodating the motor, an inverter housing accommodating an inverter electrically connected to the motor, and a gear housing accommodating a gear portion. The inverter housing opens upwardly and is arranged beside the motor housing in a direction intersecting the motor axis. The inverter housing has a bottom wall, and first through fourth side walls extending upward from the bottom wall and surrounding the bottom wall. The first and second side walls face each other, and the third and fourth side walls face each other. The inverter housing includes a first rib extending upward from the bottom wall and connecting the first side wall and the second side wall, and a second rib extending upward from the bottom wall and connecting the third side wall and the fourth side wall.

### CROSS-REFERENCE TO RELATED APPLICATIONS

The present invention claims priority under 35 U.S.C. § 119 to Japanese Patent Application No. 2021-076658 filed on Apr. 28, 2021, the entire content of which is incorporated herein by reference.

### FIELD OF THE INVENTION

The present invention relates to a drive device.

### BACKGROUND

Conventionally, various countermeasures against motor vibration have been known. For example, there is a method for reducing vibration by reducing an exciting force for exciting vibration.

However, in a drive device having a structure in which a motor housing accommodating a motor is connected to an inverter housing accommodating an inverter, membrane resonance of the inverter housing is likely to be excited by motor vibration generated when the motor is driven. For this reason, there has been a case where it is difficult to sufficiently reduce the vibration generated in the drive device as described above merely by applying a vibration countermeasure to the motor.

### SUMMARY

One aspect of a drive device of the present invention includes a motor having a rotor that rotates about a motor axis, a motor housing that accommodates the motor, an inverter housing that accommodates an inverter electrically connected to the motor, and a gear housing that accommodates a gear portion connected to the rotor. The inverter housing opens to the upper side and is arranged beside the motor housing in a direction intersecting the motor axis. The motor housing, the inverter housing, and the gear housing are connected to each other. The inverter housing has a bottom wall, and a plurality of side walls extending upward from the bottom wall and surrounding four sides of the bottom wall. The plurality of side walls includes a first side wall and a second side wall facing each other, and a third side wall and a fourth side wall facing each other. The inverter housing includes a first rib extending upward from the bottom wall and connecting the first side wall and the second side wall, and a second rib extending upward from the bottom wall and connecting the third side wall and the fourth side wall.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a conceptual view of a drive device of a preferred embodiment;

FIG. 2 is a perspective view of the drive device of the preferred embodiment;

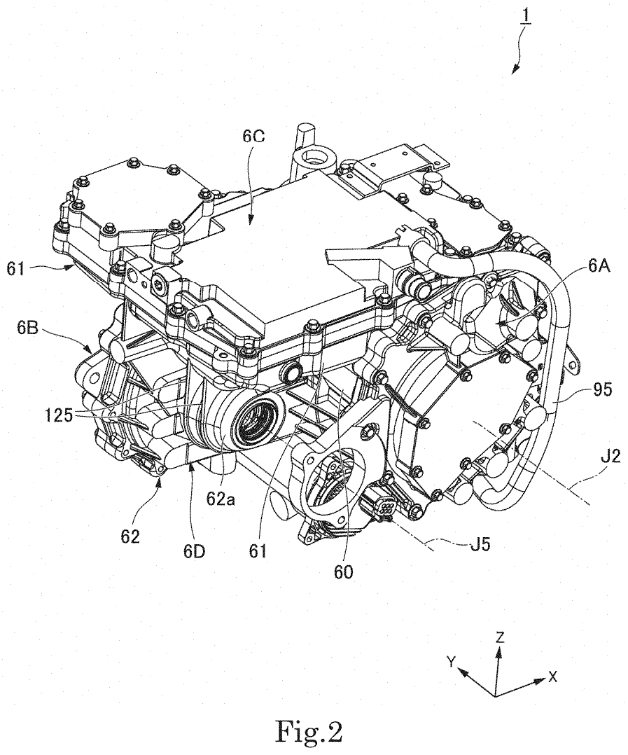

FIG. 3 is a plan view of a housing body according to the preferred embodiment;

FIG. 4 is a perspective view of the housing body according to the preferred embodiment;

FIG. 5 is a perspective view of the housing body according to the preferred embodiment;

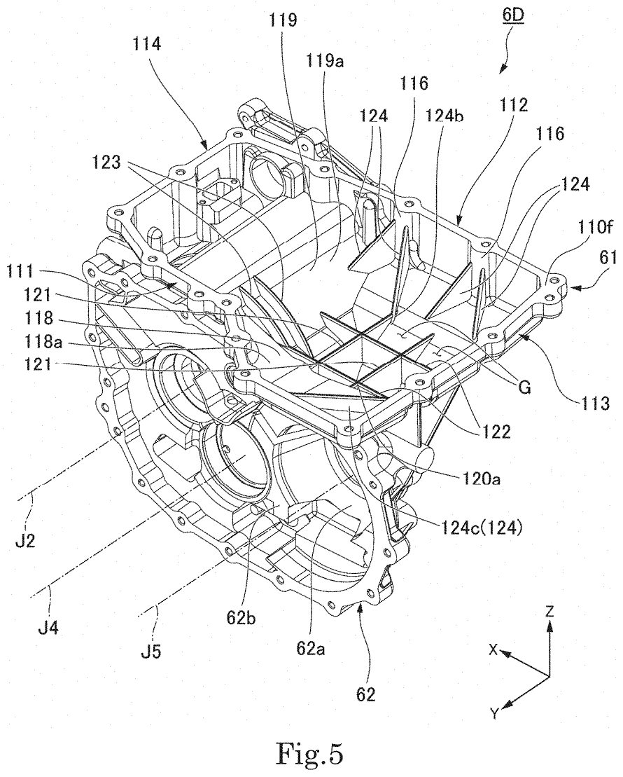

FIG. 6 is a cross-sectional view of the housing body according to the preferred embodiment; and

FIG. 7 is a cross-sectional view of the housing body according to the preferred embodiment.

### DETAILED DESCRIPTION

The description below will be made with the direction of gravity being specified based on a positional relationship in a case where a drive device 1 is mounted in a vehicle located on a horizontal road surface. Further, in the drawings, an XYZ coordinate system is shown appropriately as a three-dimensional orthogonal coordinate system. In the XYZ coordinate system, a Z-axis direction corresponds to a vertical direction (i.e., an up-down direction), and a +Z direction points upward (i.e., in a direction opposite to the direction of gravity), while a −Z direction points downward (i.e., in the direction of gravity). Further, an X-axis direction corresponds to a front-rear direction of the vehicle in which the drive device 1 is mounted, and is a direction perpendicular to the Z-axis direction, and a +X direction points forward of the vehicle, while a −X direction points rearward of the vehicle.

Note, however, that the +X direction and the −X direction may point rearward and forward, respectively, of the vehicle. A Y-axis direction is a direction perpendicular to both the X-axis direction and the Z-axis direction and indicates a width direction (lateral direction) of the vehicle. A +Y direction points left of the vehicle, while a −Y direction points right of the vehicle. Note, however, that, when the +X direction points rearward of the vehicle, the +Y direction may point right of the vehicle, and the −Y direction may point left of the vehicle. That is, the +Y direction simply points to a first side in the lateral direction of the vehicle, and the −Y direction points to a second side in the lateral direction of the vehicle, regardless of the direction of the X axis.

In the description below, unless otherwise specified, a direction (i.e., the Y-axis direction) parallel to a motor axis J2 of a motor 2 will be simply referred to by the term “axial direction”, “axial”, or “axially”, radial directions around the motor axis J2 will be simply referred to by the term “radial direction”, “radial”, or “radially”, and a circumferential direction around the motor axis J2, i.e., a circumferential direction about the motor axis J2, will be simply referred to by the term “circumferential direction”, “circumferential”, or “circumferentially”. Note, however, that the term “parallel” as used above includes both “parallel” and “substantially parallel”.

The drive device 1 according to the present preferred embodiment is mounted in a vehicle having a motor as a power source, such as a hybrid vehicle (HEV), a plug-in hybrid vehicle (PHV), and an electric vehicle (EV), and is used as a power source of the vehicle.

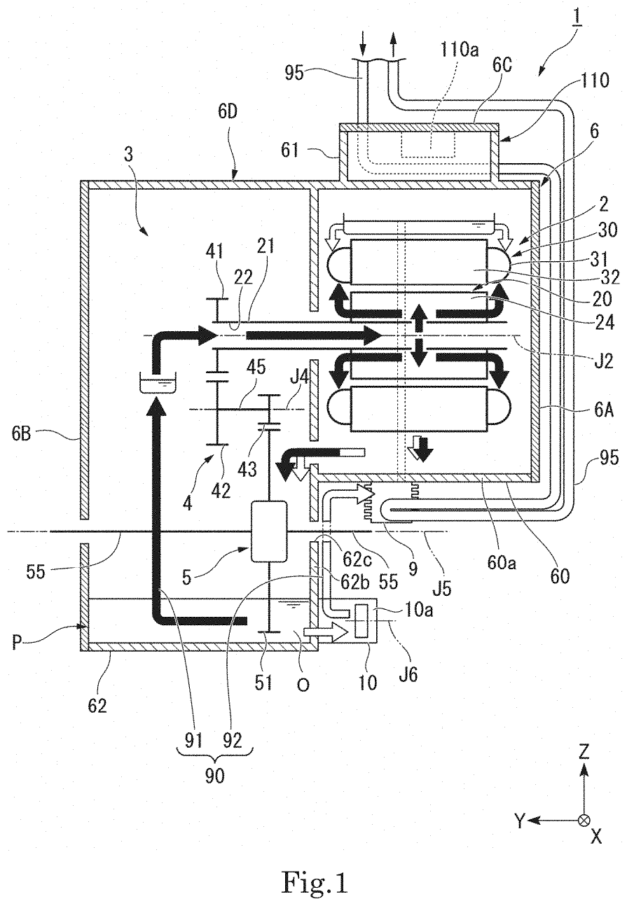

As illustrated in FIG. 1, the drive device 1 includes the motor 2, a transmission mechanism (gear portion) 3, a housing 6, oil O contained in the housing 6, an inverter unit 110, and an oil cooler 9.

The motor 2 includes a rotor 20 arranged to rotate about the motor axis J2, which extends in a horizontal direction, and a stator 30 arranged radially outside of the rotor 20. The housing 6 includes a motor housing 60 that accommodates the motor 2 and a gear housing 62 that accommodates the transmission mechanism 3.

The motor 2 is an inner rotor type motor in which the rotor 20 is arranged inward of the stator 30. The rotor 20 includes a shaft 21, a rotor core 24, and a rotor magnet (not shown).

The shaft 21 extends about the motor axis J2 extending horizontally and in the vehicle width direction. The shaft 21 is a hollow shaft having a hollow portion 22 inside. The shaft 21 protrudes from the motor housing 60 into the gear housing 62. An end portion of the shaft 21 protruding to the gear housing 62 is connected to the transmission mechanism 3. Specifically, the shaft 21 is connected to a first gear 41.

The stator 30 encloses the rotor 20 from outside in the radial direction. The stator 30 includes a stator core 32, a coil 31, and an insulator (not shown) interposed between the stator core 32 and the coil 31. The stator 30 is held by the motor housing 60. The coil 31 is connected to the inverter unit 110.

The transmission mechanism 3 is accommodated in the gear housing 62. The transmission mechanism 3 is connected to the shaft 21 on a first side in the axial direction of the motor axis J2. That is, the transmission mechanism 3 is connected to the rotor 20. The transmission mechanism 3 includes a reduction gear 4 and a differential gear 5. Torque output from the motor 2 is transmitted to the differential gear 5 through the reduction gear 4.

The reduction gear 4 is connected to the shaft 21 of the motor 2. The reduction gear 4 has the first gear 41, a second gear 42, a third gear 43, and an intermediate shaft 45. The first gear 41 is connected to the shaft 21 of the motor 2. The intermediate shaft 45 extends along an intermediate axis J4 parallel to the motor axis J2. The second gear 42 and the third gear 43 are fixed to both ends of the intermediate shaft 45. The second gear 42 and the third gear 43 are connected to each other with the intermediate shaft 45 interposed between them. The second gear 42 meshes with the first gear 41. The third gear 43 meshes with a ring gear 51 of the differential gear 5.

Torque output from the motor 2 is transmitted to the ring gear 51 of the differential gear 5 through the shaft 21 of the motor 2, the first gear 41, the second gear 42, the intermediate shaft 45, and the third gear 43. Gear ratios of the gears, the number of gears, and the like can be modified in various manners in accordance with a desired reduction ratio. The reduction gear 4 is a speed reducer of a parallel-axis gearing type, in which center axes of gears are arranged in parallel with each other.

The differential gear 5 transmits torque output from the motor 2 to an axle of a vehicle. The differential gear 5 transmits the torque to output shafts 55 of left and right wheels while absorbing a difference in speed between the left and right wheels when the vehicle turns. The output shaft 55 extends along an output axis J5 parallel to the motor axis J2. In addition to the ring gear 51 meshing with the third gear of the reduction gear 4, the differential gear 5 includes a differential gear housing, a pinion gear, a pinion shaft, a side gear, and the like (all not shown).

An oil reservoir P in which the oil O accumulates is provided in a lower region in the gear housing 62. In the present preferred embodiment, a bottom portion of the motor housing 60 is located at a higher level than a bottom portion of the gear housing 62. With this configuration, the oil O after the motor 2 is cooled can be easily recovered from a lower region of the motor housing 60 to the oil reservoir P of the gear housing 62.

A portion of the differential gear 5 soaks in the oil reservoir P. The oil O accumulated in the oil reservoir P is scraped up by operation of the differential gear 5. A part of the scraped oil O is supplied into the shaft 21. Another part of the oil O is diffused into the gear housing 62 and supplied to each gear of the reduction gear 4 and the differential gear 5. The oil O used for lubrication of the reduction gear 4 and the differential gear 5 is dropped and collected in the oil reservoir P located on the lower side of the gear housing 62.

The inverter unit 110 includes an inverter 110a electrically connected to the motor 2, an inverter housing 61 accommodating the inverter 110a, and an inverter cover member 6C fixed to the inverter housing 61. That is, the drive device 1 includes the inverter 110a and the inverter housing 61. The inverter 110a controls current to be supplied to the motor 2. The inverter 110a is fixed to a surface on the inverter housing 61 side of the inverter cover member 6C. Further, the inverter cover member 6C is fixed to the inverter housing 61. That is, the inverter 110a is fixed to the inverter housing 61 via the inverter cover member 6C.

The inverter unit 110 is located beside the motor housing 60 and is connected to an outer peripheral surface of the motor housing 60. In the present preferred embodiment, the inverter unit 110 is located on the vehicle rear side (−X side) of the motor housing 60. A cooling water pipe 95 extending from a radiator of the vehicle is connected to the inverter unit 110. The cooling water pipe 95 extends from the inverter unit 110 to the oil cooler 9.

The oil cooler 9 is located on a side surface of the motor housing 60. The cooling water pipe 95 extending from the inverter unit 110 is connected to the oil cooler 9. The oil O discharged from an electric oil pump 10 is supplied to the oil cooler 9. The oil O which passes through the inside of the oil cooler 9 is cooled through heat exchange with cooling water passing through the cooling water pipe 95. The oil O cooled by the oil cooler 9 is supplied to the motor 2.

The electric oil pump 10 is an oil pump driven by a pump motor 10a. The electric oil pump 10 sucks up the oil O from the oil reservoir P and supplies the oil O to the oil cooler 9. The pump motor 10a rotates a pump mechanism of the electric oil pump 10. In the drive device 1, a rotation axis J6 of the pump motor 10a is parallel to the motor axis J2. The electric oil pump 10 having the pump motor 10a tends to be long in the direction in which the rotation axis J6 extends. By making the rotation axis J6 of the pump motor 10a parallel to the motor axis J2, the electric oil pump 10 is less likely to protrude in the radial direction of the drive device 1. In this manner, the radial dimension of the drive device 1 can be reduced.

The oil O circulates through an oil path 90 provided in the housing 6. The oil path 90 is a path of the oil O for supplying the oil O from the oil reservoir P to the motor 2. The oil path 90 allows circulation of the oil O so that the motor 2 is cooled.

The oil O is used to lubricate the reduction gear 4 and the differential gear 5. Further, the oil O is also used to cool the motor 2. The oil O is accumulated in the oil reservoir P in a lower portion of the gear housing 62. Oil equivalent to automatic transmission fluid (ATF) having a low viscosity is preferably used as the oil O so that the oil O can perform functions of lubricating oil and cooling oil.

The oil path 90 is a path of the oil O that leads from the oil reservoir P on the lower side of the motor 2 to the oil reservoir P on the lower side of the motor 2 again via the motor 2. The oil path 90 includes a first oil path 91 passing through the inside of the motor 2 and a second oil path 92 passing through the outside of the motor 2. The oil O cools the motor 2 from the inside and the outside through the first oil path 91 and the second oil path 92.

The oil O is scraped up by the differential gear 5 from the oil reservoir P, and is led into an interior of the rotor 20 through the first oil path 91. The oil O is sprayed from the rotor 20 toward the coil 31 to cool the stator 30. The oil O that has cooled the stator 30 moves to the oil reservoir P of the gear housing 62 via the lower region of the motor housing 60.

In the second oil path 92, the oil O is pumped up from the oil reservoir P by the electric oil pump 10. The oil O is pumped up to an upper portion of the motor 2 via the oil cooler 9 and is supplied to the motor 2 from the upper side of the motor 2. The oil O that has cooled the motor 2 moves to the oil reservoir P of the gear housing 62 via the lower region of the motor housing 60.

The housing 6 includes a housing body 6D, a motor cover member 6A, a gear cover member 6B, and an inverter cover member 6C. The motor cover member 6A, the gear cover member 6B, and the inverter cover member 6C are fastened and fixed to the housing body 6D.

The housing body 6D includes the motor housing 60 that houses the motor 2, the inverter housing 61 that houses the inverter 110a, and the gear housing 62 that accommodates the transmission mechanism 3. That is, the drive device 1 includes the motor housing 60, the inverter housing 61, and the gear housing 62.

The motor housing 60 opens to a first side (−Y side) in the axial direction. The motor cover member 6A covers the opening of the motor housing 60. The gear housing 62 is open to a second side (+Y side) in the axial direction. The gear cover member 6B covers the opening of the gear housing 62. The inverter housing 61 opens upward. The inverter cover member 6C covers the opening of the inverter housing 61.

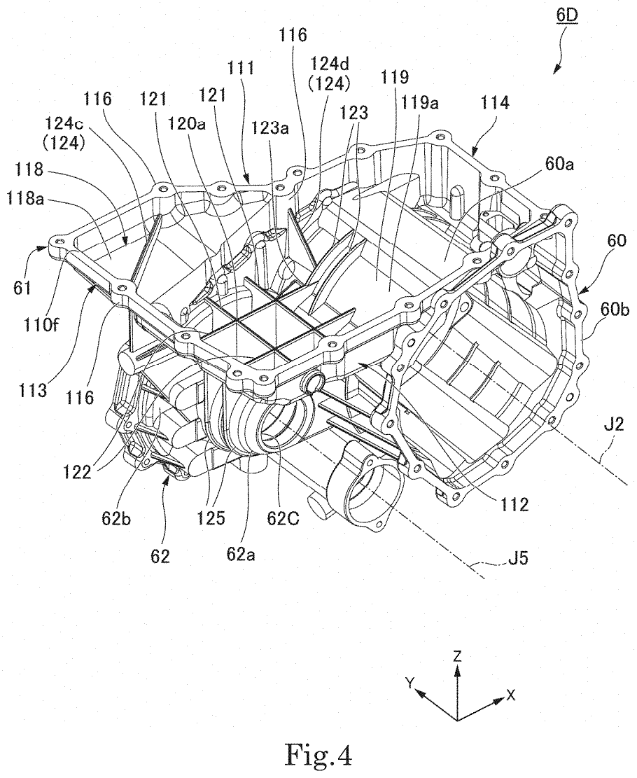

As illustrated in FIG. 4, the motor housing 60 has a cylindrical or substantially cylindrical shape extending along the motor axis J2. The motor housing 60 includes at least a cylindrical peripheral wall portion 60a that surrounds the motor 2 from the radially outer side, and a flange portion 60b provided in an end portion on the first side (−Y side) in the axial direction of the peripheral wall portion 60a. The stator 30 of the motor 2 is fixed to the inside of the peripheral wall portion 60a. The motor cover member 6A is bolted to the flange portion 60b.

The inverter housing 61 and the gear housing 62 are connected to an outer peripheral surface of the peripheral wall portion 60a of the motor housing 60 in the present preferred embodiment. That is, the motor housing 60, the inverter housing 61, and the gear housing 62 are made from a single die-cast component and are a part of the housing body 6D which is a single member.

According to the present preferred embodiment, since the motor housing 60, the inverter housing 61, and the gear housing 62 are connected to each other, the weight of the housing body 6D becomes sufficiently large, and the rigidity of the housing body 6D is enhanced. In this manner, the housing body 6D can suppress vibration during driving of the motor 2, the inverter 110a, and the transmission mechanism 3.

The gear housing 62 is arranged on the second side (+Y side) in the axial direction of the motor housing 60. The gear housing 62 rotatably supports each shaft of the transmission mechanism 3. The gear housing 62 has an outer wall portion 62b arranged on the first side (−Y side) in the axial direction of the transmission mechanism 3.

The outer wall portion 62b is located below the inverter housing 61. The outer wall portion 62b extends along a plane (XZ plane) orthogonal to the axial direction of the output axis J5. The outer wall portion 62b is provided with a differential gear holding portion 62a. The differential gear 5 (see FIG. 1) is accommodated inside the differential gear holding portion 62a. The differential gear holding portion 62a bulges to the first side (−Y side) in the axial direction around the output axis J5. The differential gear holding portion 62a is provided with a through hole 62c penetrating the differential gear holding portion 62a along the output axis J5. The output shaft 55 passes through the through hole 62c.

A fifth rib 125 is provided on an outer peripheral surface of the differential gear holding portion 62a. The fifth rib 125 extends along the circumferential direction of the output axis J5 on the outer peripheral surface of the differential gear holding portion 62a. That is, the fifth rib 125 extending along the circumferential direction of the axis (output axis J5) of the gear (ring gear 51) arranged inside the gear housing is provided on the outer peripheral surface of the gear housing 62. The fifth rib 125 enhances the rigidity of the differential gear holding portion 62a and suppresses vibration generated at the time of driving on each gear of the differential gear 5.

The inverter housing 61 opens to the upper side (+Z side) and is arranged beside the motor housing 60 in a direction intersecting the motor axis J2. In the present preferred embodiment, the inverter housing 61 is arranged on the vehicle rear side (−X side) of the motor housing 60.

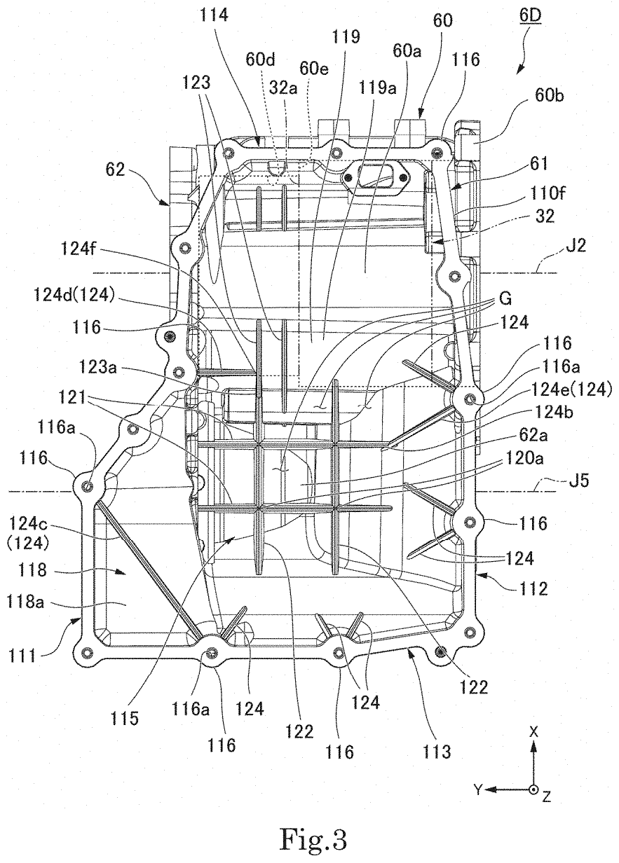

As illustrated in FIG. 3, the inverter housing 61 includes a bottom wall 115, a plurality of side walls 111, 112, 113, and 114 extending upward from the bottom wall 115 and surrounding four sides of the bottom wall 115, a flat surface portion 118, and a flange portion 110f. The inverter housing 61 has a box or substantially box shape that opens upward.

The bottom wall 115 extends in a direction orthogonal to the vertical direction. The four side walls 111, 112, 113, and 114 include a first side wall 111 and a second side wall 112 facing each other, and a third side wall 113 and a fourth side wall 114 facing each other. The first side wall 111 and the second side wall 112 are arranged along a plane orthogonal to the motor axis J2 and extend in the vertical direction. The third side wall 113 and the fourth side wall 114 are arranged along the motor axis J2 and extend in the vertical direction.

The fourth side wall 114 is arranged immediately above the motor housing 60. The third side wall 113 is located farther away from the motor housing 60 than the fourth side wall 114. The fourth side wall 114 extends upward (to +Z side) from the outer peripheral surface of the peripheral wall portion 60a of the motor housing 60. The second side wall 112 is connected to an end portion on the first side (−Y side) in the axial direction of the third side wall 113 and the fourth side wall 114. The first side wall 111 is connected to an end portion side on the second side (+Y side) in the axial direction of the third side wall 113 and the fourth side wall 114.

The first side wall 111, the second side wall 112, the third side wall 113, and the fourth side wall 114 are each provided with a plurality of bolt accommodating portions 116. The bolt accommodating portion 116 is formed to be thicker than other portions of the side walls 111, 112, 113, and 114. The bolt accommodating portion 116 is provided with a screw hole 116a that opens upward. A bolt for screwing the inverter cover member 6C is inserted into the screw hole 116a.

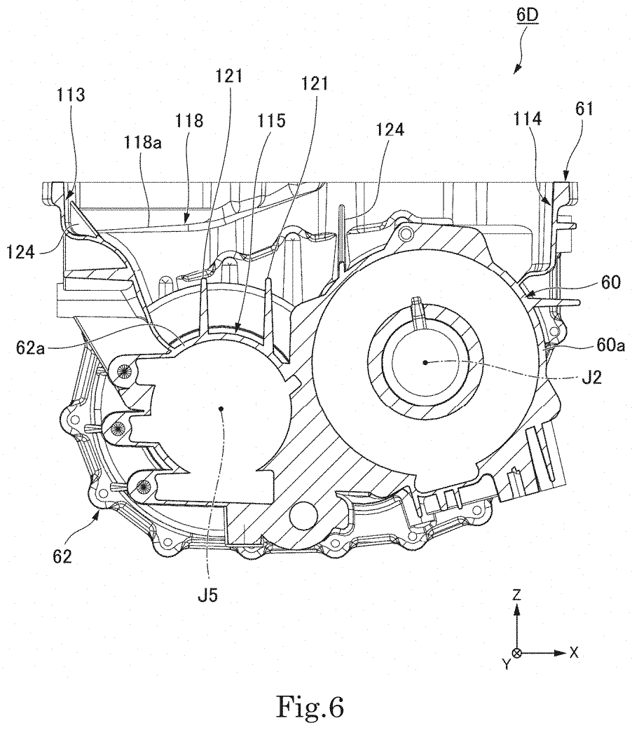

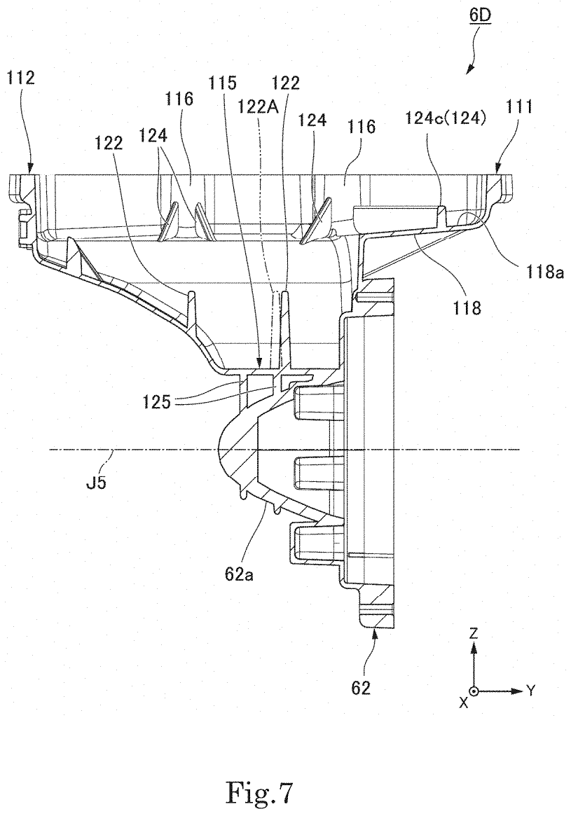

As illustrated in FIG. 7, the distance dimension between the first side wall 111 and the second side wall 112 decreases toward the bottom wall 115. Further, as illustrated in FIG. 6, the distance dimension between the third side wall 113 and the fourth side wall 114 decreases toward the bottom wall 115. The inverter 110a of the present preferred embodiment is fixed to a lower surface of the inverter cover member 6C. For this reason, the inverter 110a is arranged on the opening side (that is, the upper side) facing the upper side of the inverter housing 61 inside the inverter housing 61. Therefore, the inverter 110a is not arranged in a lower region inside the inverter housing 61. According to the present preferred embodiment, in an internal space of the inverter housing 61, the volume of a region on the lower side can be reduced, and the dead space inside the inverter housing 61 can be reduced. In this manner, the drive device 1 can be downsized.

As illustrated in FIG. 7, The flat surface portion 118 extends along a plane orthogonal to the vertical direction. The flat surface portion 118 is located at a higher level than the bottom wall 115. As illustrated in FIG. 4, the flat surface portion 118 connects the first side wall 111 and the third side wall 113. The flat surface portion 118 is arranged inside a corner portion where the first side wall 111 and the third side wall 113 intersect and are connected. The flat surface portion 118 is arranged at around the middle of the first side wall 111 and the third side wall 113 in the vertical direction. The flat surface portion 118 is provided stepwise with respect to the first side wall 111 and the third side wall 113. The flat surface portion 118 has an upper surface 118a facing upward. The upper surface 118a is a flat surface.

The flange portion 110f is located in an end portion of each of the four side walls 111, 112, 113, and 114 on the side opposite to the bottom wall 115 side, that is, on the upper end side of each of the side walls 111, 112, 113, and 114. The inverter cover member 6C is bolted to the flange portion 110f. The opening on the upper side of the inverter housing 61 is covered by the inverter cover member 6C.

The inverter housing 61 of the present preferred embodiment is provided with a pair of first ribs 121 and a pair of second ribs 122. The first rib 121 and the second rib 122 extend linearly when viewed from the vertical direction. Each of the first rib 121 and the second rib 122 extends upward from the bottom wall 115. Upper end levels of the first rib 121 and the second rib 122 coincide with each other. The pair of first ribs 121 extend parallel to each other along the motor axis J2. Further, the second ribs 122 extend in parallel to each other along the direction orthogonal to the motor axis J2.

As illustrated in FIG. 3, the first rib 121 connects the first side wall 111 and the second side wall 112. In contrast, the second rib 122 connects the third side wall 113 and the fourth side wall 114. The first rib 121 and the second rib 122 intersect each other at a right angle when viewed from the vertical direction. Here, a portion where the first rib 121 and the second rib 122 intersect and are connected to each other is referred to as an intersection 120a. Since the inverter housing 61 of the present preferred embodiment is provided with the pair of first ribs 121 and the pair of second ribs 122, the inverter housing 61 is provided with four intersections 120a.

The inverter housing 61 of the present preferred embodiment is reinforced by the first rib 121 and the second rib 122. The first rib 121 can suppress relative deformation of the first side wall 111, the second side wall 112, and the bottom wall 115 by connecting the first side wall 111, the second side wall 112, and the bottom wall 115. Similarly, the second rib 122 can suppress relative deformation of the third side wall 113, the fourth side wall 114, and the bottom wall 115 by connecting the third side wall 113, the fourth side wall 114, and the bottom wall 115. Further, the first rib 121 and the second rib 122 are connected to each other at the intersection 120a to suppress relative displacement between the first rib 121 and the second rib 122. For this reason, the first rib 121 and the second rib 122 enhance the rigidity of the entire inverter housing 61.

According to the present preferred embodiment, the first rib 121 and the second rib 122 can suppress vibration generated on the bottom wall 115 not only in one direction but also in multiple directions. In this manner, membrane vibration (membrane resonance) of the bottom wall 115 caused by vibration of the motor 2 can be suitably suppressed. Furthermore, the first rib 121 and the second rib 122 can also suppress vibration generated on the side walls 111, 112, 113, and 114 of the inverter housing 61. That is, according to the present preferred embodiment, vibration generated in the drive device 1 can be reduced, and generation of noise from the drive device 1 can be suppressed.

Further, in the present preferred embodiment, the inverter housing 61 is provided with a plurality of the first ribs 121 extending in parallel. Similarly, the inverter housing 61 is provided with a plurality of the second ribs 122 extending in parallel. According to the present preferred embodiment, it is easy to uniformly improve the rigidity of the bottom wall 115, and it is easy to suppress generation of unevenness in strength distribution in the bottom wall 115. In this manner, vibration generated on the bottom wall 115 can more stably be suppressed, and vibration generated in the drive device 1 can further be reduced.

In the present preferred embodiment, the vertical dimensions of the first rib 121 and the second rib 122 are about ⅓ of the vertical dimension of an accommodation region of the inverter 110a surrounded by the inverter housing 61 and the inverter cover member 6C. In the present preferred embodiment, an upper end position of the first rib 121 and an upper end position of the second rib 122 coincide with each other. The height of the first rib 121 and the height of the second rib 122 may be individually adjusted by a dominant vibration mode.

In the present preferred embodiment, a gap G is provided between the plurality of first ribs 121 and the plurality of second ribs 122. A part of the inverter 110a may be accommodated in the gap G. As an example, a component having a large height dimension, such as a capacitor of the inverter 110a, may be arranged in the gap G. Further, a sound absorbing member that absorbs a frequency band of a driving sound of the inverter 110a may be arranged in the gap G.

A part of the bottom wall 115 is a part of the differential gear holding portion 62a curved about the output axis J5. That is, at least a part of the bottom wall 115 is an outer surface of the gear housing 62. Further, the first rib 121 and the second rib 122 are also provided in a portion composed of the differential gear holding portion 62a of the bottom wall 115. That is, the first rib 121 and the second rib 122 extend upward from the outer surface of the gear housing 62.

According to the present preferred embodiment, a part of the gear housing 62 is reinforced by the first rib 121 and the second rib 122. The first rib 121 and the second rib 122 effectively suppress transmission of vibration of the gear housing 62 caused by the transmission mechanism 3 to the inverter housing 61.

Note that, in the present preferred embodiment, the case where both the first rib 121 and the second rib 122 are connected to an outer peripheral surface of the gear housing 62 is described. However, as long as one of the first rib 121 and the second rib 122 is connected to the outer peripheral surface of the gear housing 62, a certain effect of suppressing vibration of the gear housing 62 can be obtained. Further, in the present preferred embodiment, the number of first ribs 121 is equal to the number of second ribs 122. However, the number of first ribs 121 may be different from the number of second ribs 122.

As illustrated in FIG. 7, a fifth rib 125 provided on an outer peripheral surface of the differential gear holding portion 62a is connected to the bottom wall 115 of the inverter housing 61. Therefore, the fifth rib 125 connects the outer surface of the gear housing 62 and the bottom wall 115 of the inverter housing 61. The fifth rib 125 reinforces the gear housing 62 and reinforces the bottom wall 115 of the inverter housing 61. The fifth rib 125 effectively suppresses transmission of vibration of the gear housing 62 caused by the transmission mechanism 3 to the inverter housing 61.

The fifth rib 125 extends downward from the bottom wall 115. In contrast, the second rib 122 extends upward from the bottom wall 115. Therefore, the second rib 122 and the fifth rib 125 reinforce the bottom wall 115 from above and below. In the present preferred embodiment, in the axial direction of the motor axis J2 (that is, the Y-axis direction), the position where the second rib 122 extends and the position where the fifth rib 125 extends are shifted from each other.

The housing body 6D of the present preferred embodiment is a die-cast component. For this reason, in the housing body 6D, a blowhole is easily generated in a thick portion. According to the present preferred embodiment, by shifting axial positions of the second rib 122 and the fifth rib 125 from each other, it is possible to suppress provision of a thick portion in the housing body 6D. In this manner, it is possible to suppress formation of a blowhole inside the bottom wall 115 and to enhance the dimensional stability of the housing body 6D.

Note that, as indicated by a two-dot chain line in FIG. 7, the position where a second rib 122A extends and the position where the fifth rib 125 extends may coincide with each other in the axial direction of the motor axis J2 (that is, the Y-axis direction). In this case, the second rib 122 and the fifth rib 125 reinforce each other, and the effect of enhancing the rigidity of the bottom wall 115 can be enhanced.

As illustrated in FIG. 4, the fourth side wall 114 has a curved wall 119 curved in an arc or substantially arc shape about the motor axis J2. In the present preferred embodiment, the curved wall 119 is a part of the peripheral wall portion 60a of the motor housing 60 having a cylindrical or substantially cylindrical shape. A wall surface 119a of the curved wall 119 located inside the inverter housing 61 is a part of the outer peripheral surface of the peripheral wall portion 60a. That is, at least a part of the fourth side wall 114 is an outer surface of the motor housing 60. The wall surface 119a is a curved surface protruding toward the inside of the inverter housing 61. The wall surface 119a faces the upper side (+Z side) and the vehicle rear side (−X side).

In the present preferred embodiment, the second rib 122 is connected to the curved wall 119 which is a part of the fourth side wall 114. That is, the second rib 122 is connected to the outer surface of the motor housing 60. According to the present preferred embodiment, a part of the motor housing 60 is reinforced by the second rib 122. The second rib 122 suppresses transmission of vibration of the motor housing 60 caused by the motor 2 to the inverter housing 61.

A plurality of (two in the present preferred embodiment) third ribs 123 extending along the circumferential direction of the motor axis J2 is provided on the wall surface 119a on the inner side of the curved wall 119. The plurality of third ribs 123 is arranged at intervals in the axial direction. The third rib 123 is curved along the wall surface 119a of the curved wall 119, that is, the outer peripheral surface of the peripheral wall portion 60a of the motor housing 60.

According to the present preferred embodiment, the third rib 123 extending along the vertical direction is provided in a portion constituting the curved wall 119 of the fourth side wall 114. The curved wall 119 is also a part of the inverter housing 61 and a part of the motor housing 60. Therefore, the third rib 123 provided on the curved wall 119 reinforces the inverter housing 61 and reinforces the motor housing 60. The third rib 123 suppresses transmission of vibration of the motor housing 60 caused by the motor 2 to the inverter housing 61.

As illustrated in FIG. 3, the two third ribs 123 of the present preferred embodiment are arranged to be biased to the second side (+Y side) in the axial direction over the entire length in the axial direction of the peripheral wall portion 60a of the motor housing 60. In the present preferred embodiment, the motor housing 60 opens to the first side (−Y side) in the axial direction. The motor 2 is inserted into the motor housing 60 from the first side in the axial direction. Inside the motor housing 60, a pedestal portion 60d having a seating surface 60e located on the second side in the axial direction and facing the first side in the axial direction is provided. The stator 30 of the motor 2 is fixed as an end surface 32a of the stator core 32 abuts against the seating surface 60e. For this reason, vibration during driving of the stator 30 is transmitted from the pedestal portion 60d to the motor housing 60. In the present preferred embodiment, the axial position of the third rib 123 overlaps the axial position of the pedestal portion 60d. In this manner, the third rib 123 enhances the rigidity of the pedestal portion 60d and suppresses transmission of vibration of the stator 30 to the motor housing 60.

Further, the axial positions of the two third ribs 123 of the present preferred embodiment overlap with the axial position of the differential gear holding portion 62a. In this manner, the third rib 123 suppresses transmission of vibration of the differential gear holding portion 62a to the motor housing 60.

One of the two third ribs 123 of the present preferred embodiment is connected to one of the two second ribs 122 in a lower end portion 123a. In this manner, the rigidity of the second rib 122 and the rigidity of the third rib 123 can be enhanced, and a reinforcing effect of the inverter housing 61 by the second rib 122 and the third rib 123 can be increased. Note that such an effect can be obtained when the third rib 123 is connected to at least one of the second ribs 122.

In the present preferred embodiment, the first side wall 111, the second side wall 112, and the third side wall 113 are provided with fourth ribs 124 extending from the bolt accommodating portions 116 along the side walls. In this manner, the rigidity of the side walls 112 and 113 around the bolt accommodating portion 116 can be increased. Further, in the present preferred embodiment, the dimension in the Z-axis direction of the fourth rib 124 decreases in the extending direction.

The inverter 110a of the present preferred embodiment is fixed to the inverter cover member 6C, and the inverter cover member 6C is fixed to the bolt accommodating portion 116 of the inverter housing 61 with a bolt. Therefore, vibration generated when the inverter 110a is driven is transmitted to the bolt accommodating portion 116 of the inverter housing 61 via the inverter cover member 6C. In contrast, vibration generated when the motor 2 and the transmission mechanism 3 are driven is transmitted to the inverter cover member 6C and the inverter 110a via the bolt accommodating portion 116. According to the present preferred embodiment, transmission of vibration generated from the inverter 110a to the inverter housing 61 can be suppressed by provision of the fourth rib 124. Further, transmission of vibration of the inverter housing 61 caused by the motor 2 and the transmission mechanism 3 to the inverter 110a is suppressed.

Note that the fourth ribs 124 of the present preferred embodiment extend from the bolt accommodating portions 116 of the first side wall 111, the second side wall 112, and the third side wall 113 among the four side walls 111, 112, 113, and 114. However, if the fourth rib 124 extending from the bolt accommodating portion 116 along a side wall is provided on at least one of the first side wall 111, the second side wall 112, the third side wall 113, and the fourth side wall 114, a certain effect can be expected.

The fourth ribs 124 of the first side wall 111 extend from two bolt accommodating portions 116 of the plurality of bolt accommodating portions 116 of the first side wall 111. A fourth rib 124c extending from one bolt accommodating portion 116 of the first side wall 111 extends along the upper surface 118a of the flat surface portion 118. A fourth rib 124d extending from another bolt accommodating portion 116 of the first side wall 111 extends in the axial direction along the wall surface 119a of the curved wall 119.

The fourth rib 124d extending along the wall surface 119a of the curved wall 119 is connected to the third rib 123 in a tip portion 124f. In this manner, the third rib 123 and the fourth rib 124 reinforce each other, and the curved wall 119 can be effectively reinforced. Note that the third rib 123 and the fourth rib 124 on the wall surface 119a of the curved wall 119 can achieve a certain effect for reinforcing the curved wall 119 even if the third rib 123 and the fourth rib 124 are separated from each other.

The fourth ribs 124 of the second side wall 112 extend from two bolt accommodating portions 116 of the plurality of bolt accommodating portions 116 of the second side wall 112. A pair of the fourth ribs 124 of the second side wall 112 are provided with respect to one bolt accommodating portion 116 of the second side wall 112. The pair of fourth ribs 124 extending from the one bolt accommodating portion 116 of the second side wall 112 are provided in a V shape separated from each other with increasing distance from the bolt accommodating portion 116.

A fourth rib 124e of a part of the second side wall 112 is connected to the first rib 121 in a tip portion 124b. In this manner, the first rib 121 and the fourth rib 124 reinforce each other, and the second side wall 112 can be effectively reinforced.

The fourth ribs 124 of the third side wall 113 extend from two bolt accommodating portions 116 of the plurality of bolt accommodating portions 116 of the third side wall 113. A pair of the fourth ribs 124 of the third side wall 113 are provided with respect to one bolt accommodating portion 116 of the third side wall 113. The pair of fourth ribs 124 extending from the one bolt accommodating portion 116 of the third side wall 113 are provided in a V shape separated from each other with increasing distance from the bolt accommodating portion 116.

According to the present preferred embodiment, the second side wall 112 and the third side wall 113 are each provided with the pair of fourth ribs 124 extending in a V shape from the one bolt accommodating portion 116. For this reason, the pair of fourth ribs 124 enhance the rigidity of each other. Furthermore, the fourth ribs 124 are provided in a wide range on the side walls 112 and 113 around the one bolt accommodating portion 116. This effectively enhances the rigidity of the side walls 112 and 113 around the bolt accommodating portion 116 in a wide range. Note that the number of fourth ribs 124 is not necessarily two, and may be three or more. Further, the pair of fourth ribs 124 may extend in directions parallel to each other, and may approach each other with increasing distance from the bolt accommodating portion 116.

One fourth rib 124c of the third side wall 113 extends along the upper surface 118a of the flat surface portion 118 and is connected to one fourth rib 124 of the first side wall 111. That is, the fourth rib 124 of the first side wall 111 and the fourth rib 124c of the third side wall 113 extend along the flat surface portion 118 and are connected to each other. The fourth ribs 124 of the first side wall 111 and the third side wall 113 connected to each other can also be regarded as one rib.

In the present preferred embodiment, the flat surface portion 118 has a structure close to cantilever extending planarly in one direction in the inverter housing 61. For this reason, the flat surface portion 118 may resonate with vibration of the motor 2 and the transmission mechanism 3. According to the present preferred embodiment, since the fourth rib 124 extends across the flat surface portion 118, the rigidity of the flat surface portion 118 can be effectively enhanced, and resonance of the flat surface portion 118 can be suppressed.

Although various preferred embodiments of the present invention are described above, configurations in the preferred embodiments and a combination of the configurations are examples, and thus addition, elimination, replacement of a configuration, and other modifications can be made within a range without departing from the spirit of the present invention. Further, the present invention is not limited by the embodiments.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive device comprising:
a motor having a rotor that rotates about a motor axis;
a motor housing that accommodates the motor;
an inverter housing that accommodates an inverter electrically connected to the motor; and
a gear housing that accommodates a gear portion connected to the rotor, wherein
the inverter housing is open on an upper side and is arranged beside the motor housing in a direction intersecting the motor axis,
the motor housing, the inverter housing, and the gear housing are connected to each other,
the inverter housing has a bottom wall, and a plurality of side walls extending upward from the bottom wall and surrounding four sides of the bottom wall,
the plurality of side walls includes a first side wall and a second side wall facing each other, and a third side wall and a fourth side wall facing each other, and
the inverter housing includes
a first rib extending upward from the bottom wall and connecting the first side wall and the second side wall, and
a second rib extending upward from the bottom wall and connecting the third side wall and the fourth side wall.

2. The drive device according to claim 1, wherein
at least a part of the bottom wall is an outer surface of the gear housing, and
at least one of the first rib and the second rib extends upward from the outer surface of the gear housing.

3. The drive device according to claim 1, wherein
at least a part of the fourth side wall is an outer surface of the motor housing, and
the second rib is connected to the outer surface of the motor housing.

4. The drive device according to claim 1, wherein
at least a part of the fourth side wall is the outer surface of the motor housing, and is provided with a third rib extending along a vertical direction.

5. The drive device according to claim 4, wherein
the third rib is connected to at least one of the second ribs.

6. The drive device according to claim 1, wherein
at least one of the first side wall, the second side wall, the third side wall, and the fourth side wall is provided with a bolt accommodating portion and a fourth rib extending from the bolt accommodating portion along the side wall.

7. The drive device according to claim 6, wherein
a pair of the fourth ribs are provided for one bolt accommodating portion, and
the pair of fourth ribs are separated from each other with increasing distance from the bolt accommodating portion.

8. The drive device according to claim 6, wherein
the inverter housing further includes a flat surface portion connecting the first side wall and the third side wall,
the bolt accommodating portion and the fourth rib are provided on each of the first side wall and the third side wall, and
the fourth rib of the first side wall and the fourth rib of the third side wall extend along the flat surface portion and are connected to each other.

9. The drive device according to claim 1, wherein
a fifth rib extending along the circumferential direction of an axis of a gear arranged inside the gear housing is provided on an outer peripheral surface of the gear housing, and
the fifth rib connects the outer surface of the gear housing and the bottom wall.

10. The drive device according to claim 9, wherein
an extending position of the second rib and an extending position of the fifth rib are shifted from each other in an axial direction of the motor axis.

11. The drive device according to claim 9, wherein
an extending position of the second rib and an extending position of the fifth rib coincide with each other in an axial direction of the motor axis.

12. The drive device according to a claim 1, wherein
a distance dimension between the first side wall and the second side wall decreases toward the bottom wall.

13. The drive device according to claim 1, wherein
a distance dimension between the third side wall and the fourth side wall decreases toward the bottom wall.
